(19) United States
(12) Patent Application Publication
(10) Pub. No.: US 2009/0212902 A1
(43) Pub. Date: Aug. 27, 2009

(54) SYSTEM AND METHOD FOR AUTHORIZING LIMITED ACCESS

(75) Inventor: Richard M. Haddock, Redwood City, CA (US)

Correspondence Address: SCHNECK & SCHNECK, P.O. BOX 2-E, SAN JOSE, CA, 95109-0005, US

(73) Assignee: LASERCARD CORPORATION, Mountain View, CA (US)

(21) Appl. No.: 12/390,609

(22) Filed: Feb. 23, 2009

Related U.S. Application Data
(60) Provisional application No. 61/030,492, filed on Feb. 21, 2008.

(51) Int. Cl. H04L 9/32

(52) U.S. Cl. 340/5.2

(57) ABSTRACT

A system and method for securely controlling access to a designated location with a single card having a permanent data storage medium and a temporary data storage medium disposed on the card. Biometric information is acquired from a person and written on the permanent storage medium. A verification terminal acquires biometric information from a possessor of the card, such as random and multiple biometric information, and reads the same type of biometric information from the permanent storage medium of the card. Upon a favorable comparison of biometric information of the card and card possessor, authorization data is written on the card specifying limited access. The biometric information and the authorization data can be uploaded to a local database. The type of biometric information to be acquired from the card possessor and read from the card is accessed from the database. If the biometric information from both the card and the possessor match, and if access attempted by the card possessor is in accordance with the limits of the authorization data, access will be granted.

### CROSS-REFERENCE TO RELATED APPLICATION

This application claims priority from U.S. Provisional Application Ser. No. 61/030,492 filed Feb. 21, 2008.

### TECHNICAL FIELD

The present invention relates to the use of personal identification cards for providing authorized access.

### BACKGROUND

Plastic cards carrying magnetic stripes are widely used as credit cards, debit cards, automatic teller machine (ATM) cards, telephone payment cards, etc. Typically, these cards hold approximately 200 alphanumeric characters, which is the same as 200 numeric bytes of data in computer language. The magnetic stripe is erasable and is read and written by a wide variety of commercial devices. A variety of methods are used to enhance the security of such cards and to discourage fraudulent use.

U.S. Pat. No. 5,457,747 to Drexler et al. describes a system for deterring fraudulent use of wallet-size cards in local benefit dispensing terminals utilizing a card having a permanent data storage medium and a temporary data storage medium disposed on the card. A first card writing device has means for acquiring biometric information from a person and for writing a template of that information on the permanent storage medium. A verification terminal has similar means for acquiring biometric information from a possessor of the card, and also has means for reading the biometric information from the permanent storage medium of the card. Upon inputting biometric information from both the card and the possessor of the card, the verification terminal compares the information, and if they match, writes data allowing limited benefits on the temporary data storage medium of the card. This data can be read by a plurality of existing benefit dispensers at other locations, which can then dispense the benefits authorized by the data.

U.S. Pat. No. 5,412,727 to Drexler et al. describes an anti-fraud voter registration and voting system using a data card having a permanent and temporary data storage medium where biometric information is permanently recorded and data authorizing limited use to obtain benefits is temporarily recorded. The use authorized by the data stored on the second area at voting terminals may be limited in time, issues to be voted on, political party affiliation, geography of the voting terminals or the voter's residence.

Data cards, such as the ones described above, utilizing temporary and permanent storage areas, dispense benefits. Anti-fraud methods are incorporated in the system of benefit dispensation.

### SUMMARY

A method utilizing, and a system including, a card having two data storage areas where the card provides limited authorized access to a designated location. In the first storage area, biometric identifying information of an individual is permanently recorded. The second storage area is used to write data authorizing access to a designated location, for example, beyond a checkpoint terminal for a limited time. The checkpoint terminals are located in, for example, an airport, governmental building or border crossing, or other areas in which authorized access is important. The authorization data is written in the second storage area after matching biometric information of the cardholder with that stored on the first storage area of the card at a verification terminal. The first storage area may be an optical medium stripe or a semiconductor memory chip, and the second storage area may be a semiconductor memory chip, but the same optical medium stripe or a magnetic stripe could also be the second storage area. Biometric information, such as multiple and/or random information, which is selected and verified at the verification terminal, is uploaded to a local database, and later accessed at a checkpoint terminal. The random and multiple biometric information requested at the verification terminal, may be a fingerprint template, a template of a hand scan and/or a signature data. The next time a card possessor checks in at a verification terminal, different biometric data such as, a voice print, a retina scan, or a face photo may be requested. The biometric data that is requested is random, thus each time a card possessor registers at a verification terminal it is not known which biometric information may be requested. This greatly reduces the opportunity for hacking or bio-code breaking. The access to an area, authorized by the authorization data stored on the second storage area, may be limited in time to a period of days, weeks or months. Access to an area may also be limited in terms of the starting date and/or time of the granted access and in terms of the particular checkpoint or checkpoints beyond which access is granted.

Authorization data can also be uploaded to the database and linked to the biometric data. This provides an extra security measure at the checkpoint terminal as described below.

When access beyond the checkpoint terminal is desired, the card is inserted into the checkpoint terminal. The second storage area is read and the appropriate biometric data stored in the first area is read. The appropriate biometric data to be read and requested from the card possessor can be determined from accessing the database, which has stored biometric data requested at the verification terminal. The checkpoint terminal requires the possessor of the card to provide biometric information. This newly acquired biometric data is compared to that previously stored on the card to determine if the card possessor is the same person as the registered owner. If the card possessor's biometric information is a match with that information on the card, and if it is confirmed through reading the semiconductor chip second area, that the possessor has not overstepped the bounds of the limitation granted by the authorization data, the card possessor is authorized to access the area beyond the checkpoint for a given period of time or other limit as specified. In one example, authorization data on the card is compared with authorization data stored on the database. A match must occur for access to be granted.

A procedure can be followed to prevent claiming benefits under a variety of names. Under this procedure, biometric information acquired by each or one of the writer, verification terminal and checkpoint terminal is sent by telecommunications to a central point where, for example, an electronic fingerprint and voice print, is compared with all fingerprints and voice prints of all entitlement recipients to determine whether the same fingerprint and voice print have been used with other registered names. This procedure may be conducted on-line, or the biometric data may be periodically electronically or physically collected from the checkpoint terminals.

An advantage presented is that authorized access to pre-designated locations is provided and non-authorized access is prevented through the use of a single card. Random biometric data is requested at the verification terminal. Requesting random biometric data makes it more difficult for targeted hacking of the system and/or bio-code breaking to occur. Also, the authorization data can be linked to the biometric data in the database. Thus, though a cardholder's biometric data may match with the data on the card, if the authorization data fails to match the data stored in the database, access to the designated location will be denied. Further, the disclosed technology provides a system and method that securely controls and limits access to certain areas. The limitation on access, the random selection of multiple biometric data, and the required repeated verification at each checkpoint enhances security of the areas beyond the checkpoint.

### BRIEF DESCRIPTION OF THE DRAWINGS

FIG. 1 is a diagram illustrating the procedural steps in the system disclosed.

FIG. 2 is a plan view of devices used for acquiring, storing, reading and comparing biometric information of FIG. 1.

FIG. 3A is a flow chart illustrating use of the system shown in FIG. 1.

FIG. 3B is a flow chart illustrating use of the system shown in FIGS. 1 and 3A.

### DETAILED DESCRIPTION

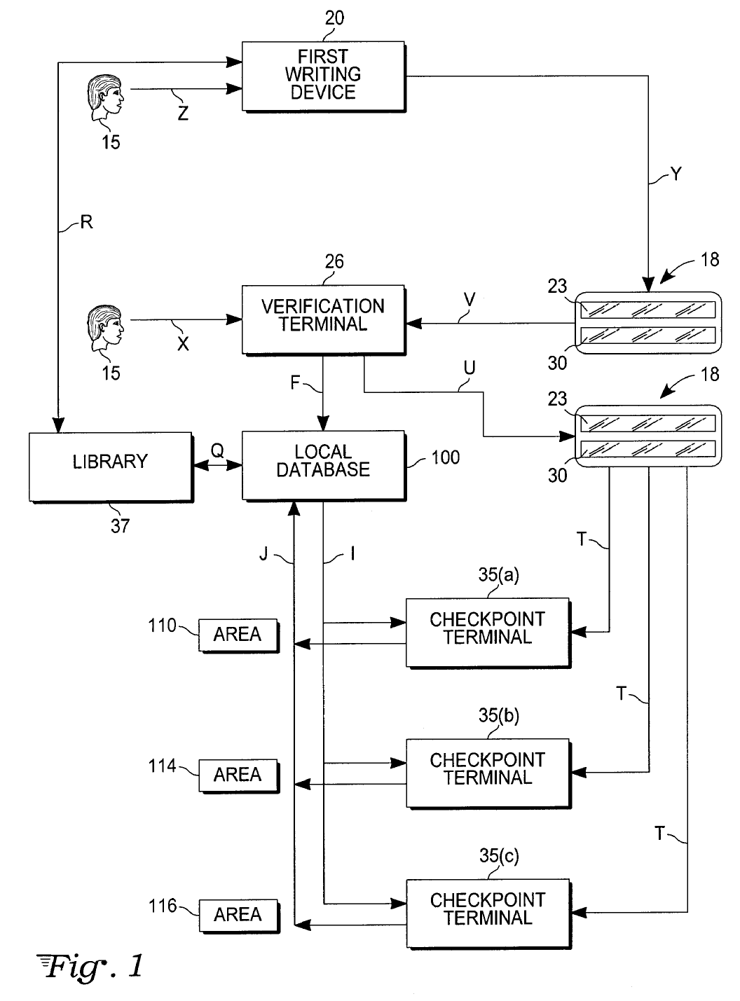

Referring now to FIG. 1, a person 15 for which a personal identification card 18, preferably wallet size, is to be made, presents biometric identification information to a first writing device 20. The biometric information of the person 15 may include individual characteristics such as a fingerprint or fingerprints, a handprint, a voice-print, a facial picture, a retinal scan or a signature. The first writing device 20 has means for acquiring this biometric information from the person, represented by arrow Z.

The means for acquiring biometric information from a person, used by first writing device 20, are not shown in this figure but may include commercially available electronic devices for receiving information relating to the person's face, fingerprint, handprint, retinal scan or signature. A microphone may be used for acquiring voice print information. A video recording device may be used for recording information, which allows viewing and listening to such information over a period of time. With any of these acquisition means, the biometric information to be stored may be converted to a template or templates offering a compressed version of the data containing essential identifying features. The biometric information, or a compressed version of that information, may also be stored in an encoded form for enhanced security. The information, which is stored, may be any of the above listed types of biometric information or may be a combination of the above listed types of information.

The first writing device 20, after acquiring biometric information from the person, writes that information indelibly on a permanent data storage medium 23 of the card 18. This information is preferably written in a compressed or template form. The permanent data storage medium 23 may be an optically reflective strip which can be written by a laser recording device, the written areas thereafter read by the same or another laser at reduced power or a light emitting diode in order to retrieve the stored information. Alternatively, the permanent storage medium 23 may be a non-erasable memory such as a semiconductor chip which is recorded in a programmable read only memory (PROM), adapted for permanent recording. Any other medium which can store moderate to large amounts of information which can be indelibly written upon and later retrieved can instead be used as the permanent storage medium 23, although an optical data storage device as described above is preferred as it affords a high data storage density, e.g., more than 2 k bytes, is low cost and commercially available. After writing a template of the biometric information indelibly on permanent data storage medium 23, first writing device 20 dispenses card 18 as shown by arrow Y. First writing device 20 may be located in an office, such as an immigration office or passport agency, or at an airport, travel agency, border crossing or any other desired location.

In order to use the card 18 to obtain access to a designated location, the person 15 takes the card 18 to a verification terminal 26. The verification terminal 26 has means for acquiring biometric information from the person 15 indicated by arrow X which is similar to the biometric information acquisition means utilized by first writing device 20. At the verification terminal 26 it is desirable that biometric information is randomly selected from the types of biometric information recorded by first writing device 20 and that the random, selected type of information is acquired from the person 15 by verification terminal 26. The acquired biometric information includes a least one type of biometric information, for instance, a fingerprint, and desirably includes greater than one or multiple types of biometric information, for instance a fingerprint, a voiceprint, and a retina scan. As the biometric data is randomly selected, the chances of a computer hacker succeeding in defrauding the system are decreased. For example, a hacker may have obtained a voice print of the card possessor 15, however, the verification terminal 26 will not always request the voice print, in which case a hacker would be prevented from hacking the system with merely the voice print. Also, the verification terminal 26 may request multiple types of biometric identification information. For instance, it may request a voice print in addition to a finger print. Again, the hacker's attempt to defraud the verification terminal 26 would be thwarted. The invention may be practiced without a first writing device 20, by using the verification terminal 26 to perform the functions of the first writing device 20 as well as the other described functions of the verification terminal 26.

Verification terminal 26 receives the card 18 containing biometric information written indelibly on the permanent storage medium 23, as indicated by arrow V. Verification terminal 26 has a means for reading the template of biometric information stored on permanent storage medium 23. For example, if permanent storage medium 23 is an optical storage strip that has been recorded with a laser beam to store the template data, verification terminal 26 has a less powerful laser or light emitting diode beam that is directed at the medium 23 and a detector of reflected, transmitted or refracted light is used to read the data stored on the medium 23.

Verification terminal 26 also has a means for comparing the biometric template read from permanent storage medium 23 with the biometric information that the verification terminal 26 has acquired from the person 15. This means for comparing biometric information will typically include a microprocessor, not shown in this figure. If the biometric information from the card 18 matches that from the person 15, the identity of the person 15 has been verified, and the verification terminal 26 writes authorization data on a temporary storage medium 30 of the card 18, as indicated by arrow U. Typically the capacity of storage medium 30 is low, for example, about 200 bytes. The data written on temporary storage medium 30 is authorization data, which allows the card 18 to be used to obtain specified benefits. For example, the authorization data specifies the type of access which may be granted to the card possessor. Authorization data may limit the card possessor access to one of more locations, a specified amount of access time, or otherwise. The access, which can be obtained by the card 18, is limited in order to maintain the integrity of the card 18 by frequent verification of the identity of the possessor of the card 18. Should the person 15 have different biometric information than that indelibly recorded on the permanent storage medium 23, the comparison would not match and the card would not be imprinted with authorization data allowing limited use. In one example, the comparison would be made several times before a negative conclusion is reached. In one embodiment, storage medium stripe 23 and storage medium stripe 30 could be two parts of one optical medium stripe.

In addition, other measures may be employed by the verification terminal 26 in response to a confirmed mismatch, such as surreptitiously photographing the person 15 or activating an alarm to enable apprehension of the person 15. There is, however, a possibility of inaccuracy in matching biometric information. The use of fingerprints for matching of biometric information permits approximately one unauthorized person to be accepted out of 100,000 acceptances. Handprint matching is faster, but the chance of unauthorized acceptance may be one chance in one thousand. To improve handprint accuracy, matching of handprints may be combined with matching biometric information of another personal feature. Further combination of matching would yield further reduction in this type of error.

Temporary storage medium 30 is typically a semiconductor memory chip affixed to a plastic card, which can be read and rewritten, and for which a low cost RF reader can read. Other desired storage media may be used, such as a magnetic recording stripe.

The biometric data selected, for example, random and multiple biometric data, is uploaded to a database such as local database 100 from the verification terminal 26 as indicated by arrow F. This may include biometric data on the card and newly acquired biometric data. The corresponding authorization data allowing limited use of the card may also be uploaded to local database 100 from the verification terminal 26, as also indicated by arrow F. The authorization data and biometric data can be linked to one another. The card can then be used to provide authorization for limited admittance to a designated area or areas, for example, areas, 110, 112, and 114, secured with one or more local card checkpoint terminals 35, for example check point terminals 35(a), 35(b), and 35(c).

After temporary storage medium 30 of card 18 has been written with authorization data allowing limited access, the card 18 can be brought to a local checkpoint terminal as depicted by arrows T, so that a person 15 can attempt to obtain access to a designated location beyond a particular checkpoint terminal, for example 35(a), 35(b) or 35(c). Each checkpoint terminal requires the possessor of the card to provide the biometric information corresponding to the biometric information stored in the database. The selected checkpoint terminal 35(a), 35(b), or 35(c) contacts the local database 100 as seen by arrow J, to obtain the biometric data initially selected at the verification terminal 26. Retrieval of the biometric data is seen by arrow I. The biometric data corresponding to the stored biometric data is inputted from both the card 18 and the possessor of the card 15 at the selected checkpoint terminal and the checkpoint terminal reads the biometric data on the card 18 for re-verification. The newly acquired biometric data from the card possessor is compared to that previously stored on the card 18 to determine if the card possessor 15 is the same person as the original owner. The checkpoint terminal also reads authorization data on temporary storage medium 23. For example, the checkpoint terminals 35(a), 35(b), and 35(c) each include readers such as a RF reader (not shown) to read semiconductor chip data. The newly acquired biometric data, and/or authorization data read from the card can and/or biometric data from the card be uploaded to the database 100 as indicated by arrow J.

In one example, if the biometric data from both the card 18 and the possessor 15 match, but the authorization data on the card is different from the corresponding authorization stored in the database, authorized access to a location beyond a particular checkpoint terminal is denied. In another example, if the biometric data from both the card 18 and the possessor 15 match, and if the authorization data on the card authorizes access beyond a particular checkpoint, 35(a), 35(b), or 35(c), the card possessor will be granted access to locations that do not overstep the bounds of the authorization granted. For example, the card possessor may have been granted the authorization to enter area 110 through checkpoint terminal 35(a) with the specified authorization data. In another, example the card possessor may have been granted authorization to enter areas 110, 112, and 114 through checkpoint terminals 35(a), 35(b), and 35(c) with the specified authorization data. In any event, should the card possessor have different biometric information other than that indelibly recorded on the permanent storage medium 23, the comparison would not match and the card possessor would not be granted access beyond a checkpoint terminal. In one example, the comparison would be made several times before a negative conclusion is reached. Access to a location or combination of locations (designated on temporary medium 30, for example) through a particular checkpoint terminal or combinations of checkpoint terminals may be authorized. Upon verification, the card possessor is authorized to access the designated area beyond the checkpoint terminal. For instance, the card possessor may access area 110 beyond checkpoint terminal 35(a). The access may be limited to a specified period of time or some other limitation may apply as specified by the card. The limitation on access, the random selection of biometric data which can be multiple, and the required repeated verification at each checkpoint terminal enhances security of the areas beyond the checkpoint.

A checkpoint terminal may be located in the general vicinity of each verification terminal 26 used as first writing devices, but many other distal checkpoint terminals may exist for each verification terminal 26. The verification terminals 26 may be installed in secure, convenient locations, such as airports, border crossings, post offices, shopping centers or city, county, state or federal buildings. Checkpoint terminals may outnumber verification terminals 26 by a factor of ten or more to one.

The form of access authorized by the data written on temporary medium 30 may include access beyond an airline counter, airport gate, departure or arrival terminal, airplane, customs, and border. The geography in which benefits are authorized may include specific cities, states, countries, or specific checkpoint terminals within those regions.

The authorization data written on temporary storage medium 30 may allow use that is limited in time, limited in form, limited in geography, or otherwise limited or may allow use that includes a combination of these limits. For example, authorization data may only allow access to be granted from a particular checkpoint terminal to a designated location for a designated number of minutes or hours, days, weeks or months. For example, the authorization data may allow access to a designated airport gate, or may allow access to a designated gate for 2 hours after the time of verification. The limit on the access which can be obtained from the card 18 before re-verification at another checkpoint terminal creates a ceiling on the access that can be fraudulently obtained.

In order to circumvent fraudulent use of multiple cards 18 by a person entitled to use only one card 18, a library 37 (FIG. 1) of biometric information, such as security database can be maintained. The library 37 can be in direct communication with the first writing device 20 directly as shown by arrow R or in indirect communication through a database. The library can also be in direct communication with the verification terminal 26 and checkpoint terminal 35(a), 35(b), or 35(c) (not shown) or in indirect communication through local database 100 as shown by arrows Q. The biometric information from the permanent storage medium 23 can be uploaded to the database 100, stored at the database 100 and compared with data in the library 37. When biometric information is acquired from a person 15 at first writing device 20, that information is checked against the other biometric information on file at the library 37. Should matching biometric information exist at the library 37 under another name, the issuance of a card 18 written indelibly with such information on permanent storage medium 23 is averted, an alert, such as a duplication alert, is signaled and apprehension measures may additionally be actuated. Upon receiving biometric information which does not match that already on file at the library 37, that information is added to the library 37 along with corresponding common identification data such as the person's name, social security number, etc. Since comparing the biometric information with the information in the library takes considerable time, it is preferably done with the first writing device.

Communication between the verification terminal 26 and the library and/or the checkpoint terminal, for example, 35(a), 35(b), or 35(c), and the library 37 can be used to circumvent fraud. Should biometric information contained on permanent storage medium 23 or acquired from the card possessor match with such information on file at the library under another person's name, data allowing limited access benefits to be obtained would be denied, and apprehension measures may additionally be employed. In these examples, apprehension may be aided by the fact that a name and address used by the person is on file.

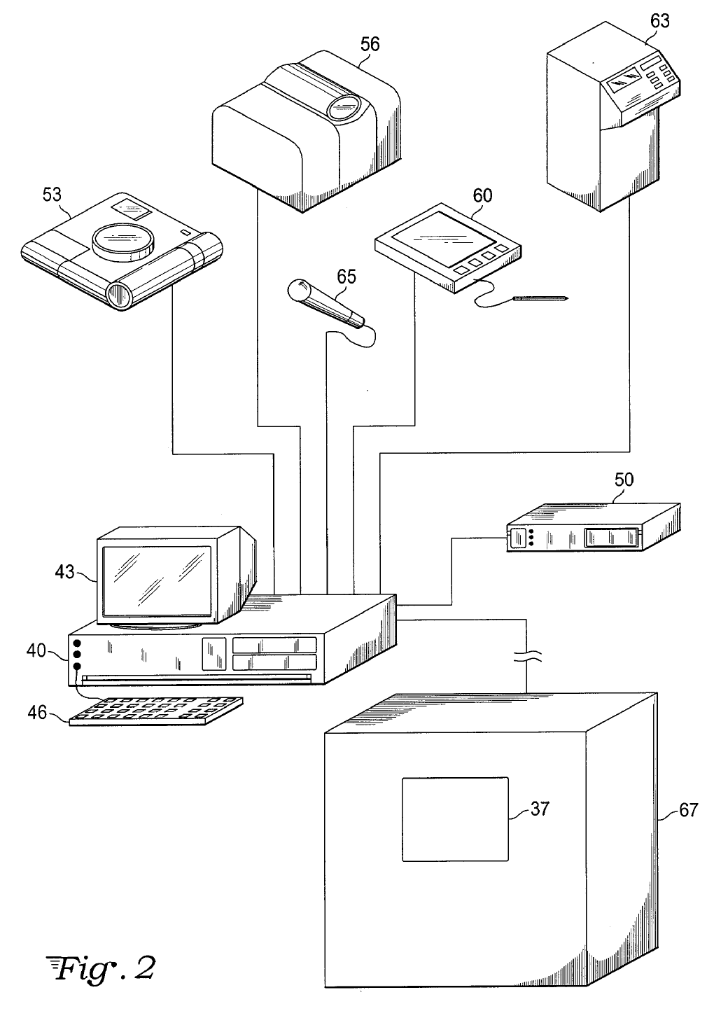

Referring now to FIG. 2, five types of biometric recording devices are illustrated, each connected to a computer 40 including a monitor 43 and a keyboard 46. Only one type of biometric data is needed, but several possibilities are illustrated in FIG. 2. Also connected to the computer 40 is a card read/write device 50. The keyboard 46 and computer 40 are also used for acquiring common identification from the person, such as the person's name, social security number, date of birth, etc., to be recorded on the permanent storage medium 23.

An electronic camera 53 for taking a picture of a person's face or a retinal scan may be employed for acquiring biometric information. Such a camera may utilize a charge coupled device (CCD) capable of sending a digital representation of the picture to the computer 40, which may in turn extract characteristic information from the picture to be recorded as a template on the permanent storage medium 23 or compared with template information read from the permanent storage medium 23. A fingerprint reader 56 can similarly scan a person's fingerprint, and may acquire a two or three-dimensional picture of the fingerprint for transmission to the computer 40.

An electronic signature reader 60 can electronically record and transmit to the computer 40 a digital representation of a person's signature. That signature can be enlarged and displayed on the monitor 43 adjacent a previously recorded signature for visual comparison. Alternatively, the computer 40 can compare the signatures to determine whether they match, or both a human determined and computer 40 determined comparison can be made. A handprint reader 63 can also be connected to the computer 40 to capture and compare a three dimensional digital representation of a person's hand. A microphone 65 can capture a person's voice, and a sound card within the computer 40 can store a digital voice print.

The computer 40 is also able to communicate with the central library 37, which may be housed within a mainframe computer 67 having extensive memory capacity. Alternatively, the library 37 may be comprised of an interconnected network of verification terminals 26 and first writing devices 20 and checkpoint terminals.

All of the devices shown in FIG. 2 except for the mainframe computer 67 may together constitute a verification terminal 26, including one or any combination of the five biometric recording devices shown or other biometric recording devices. A first writing device 20 may be comprised of one or any combination of the five biometric information recording devices shown, in connection with a card read/write device 50.

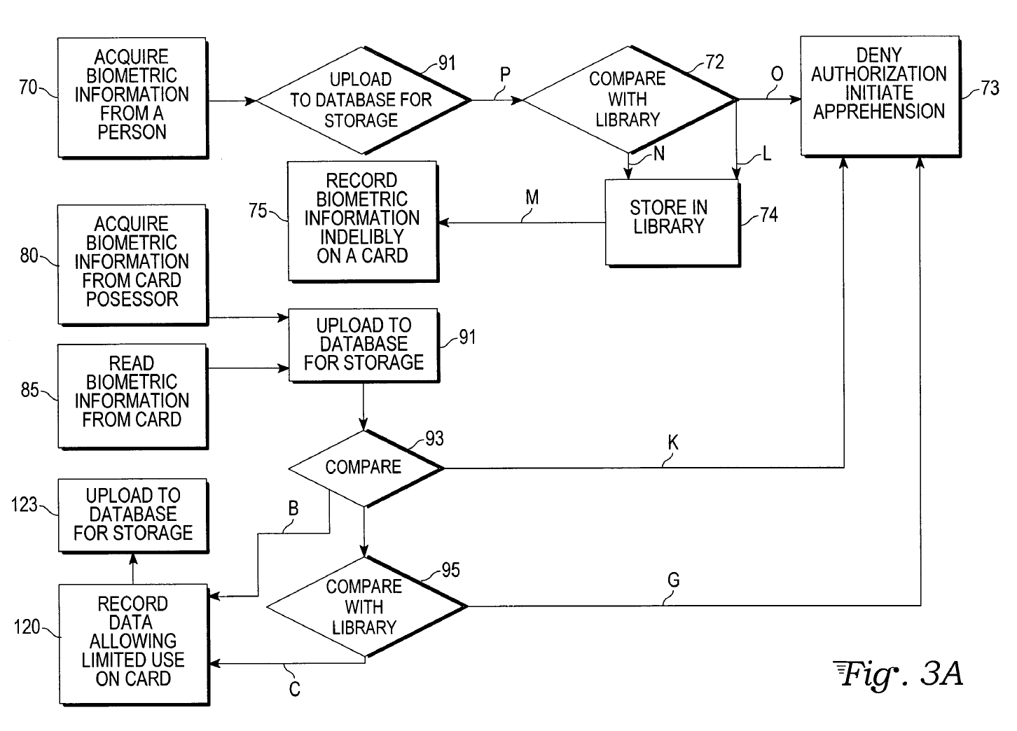

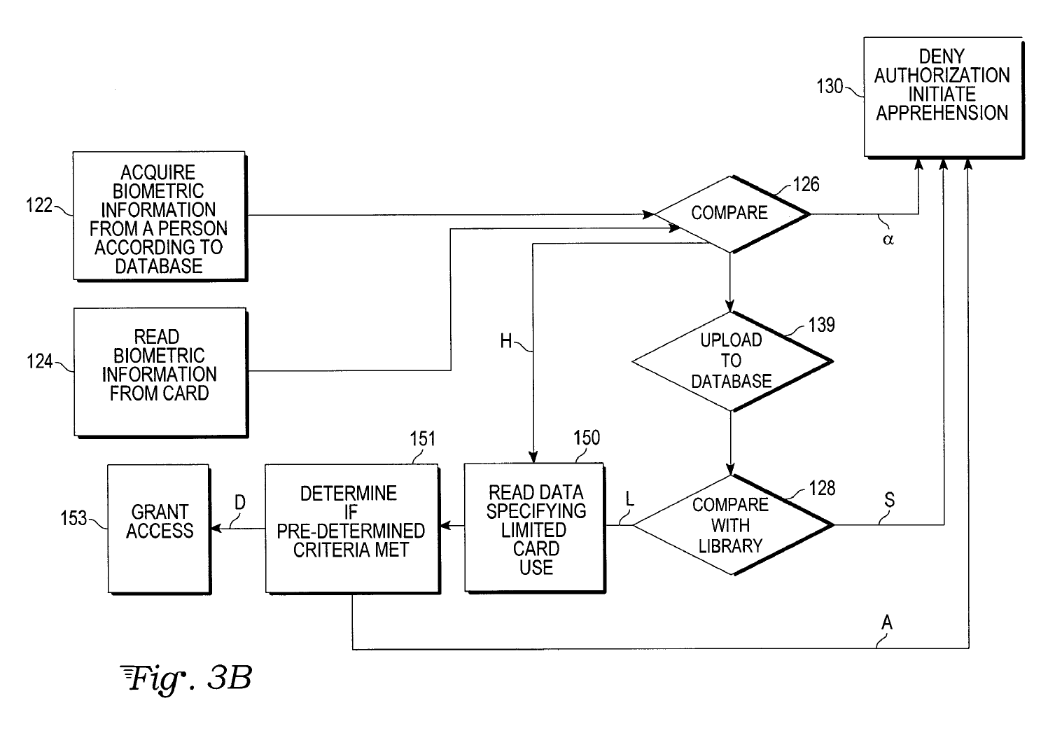

FIGS. 3A and 3B show an outline of the steps and system of the described embodiments. With reference to FIG. 3A, at either a first writing device or verification terminal used as a first writing device, biometric information is acquired from a person, as illustrated by block 70. A digital representation of this information, as provided by biometric recording device, can be uploaded to a local database and stored as shown in block 91. From the database the information is sent via telecommunications such as radio waves or phone lines to the library, as shown by arrow P, where it is compared, as shown by block 72, with the biometric information at the library. The information can be sent to the library via the database after being acquired at a verification terminal or sent directly to the library. If this comparison yields a match with biometric information under a different name, social security number or other common identification, as shown by arrow O, authorization for access benefits is denied, and apprehension measures may be initiated, as shown in block 73. If the biometric information given by the person does not match any such information at the library 74, with input shown by arrow N, it is stored at the library, along with the name and any other commonly used identification data. A signal is also sent from the library to the terminal where this information was acquired, as shown by arrow M, authorizing recording of this information on a card. According to block 75, this information is then recorded indelibly on a card. If the biometric information acquired from the person matches such information on file at the library, and the name and other common identification is identical with that given, indicating a lost or stolen card, as indicated by arrow L, additional information is stored at the library 74 indicating that a replacement card has issued, and a signal is sent, shown by arrow M, to the terminal, where the biometric information was acquired, authorizing recording, as illustrated in block 75, of the biometric information indelibly on a card. Along with the biometric information, common identification information and information that the card is a replacement card is recorded on the card.

At a verification terminal, biometric information, for example, random biometric information, is acquired from the possessor of the card, as shown in block 80 and is uploaded to a local database as illustrated by block 91. Biometric information is also read from the card, according to block 85 and can be uploaded, if desired, as seen in block 91. The order of performance of blocks 80 and 85 is immaterial. It is desired that the biometric information is multiple and/or random. The biometric information of the card and of the possessor of the card is then compared 93. If a non-favorable comparison occurs, for instance, if the biometric information on the card and that of the possessor of the card do not match, steps 80, 85 and 93 are repeated to confirm a mismatch. If a mismatch is confirmed, as shown by arrow K, authorization is denied, as shown by block 73, and apprehension measures may be initiated. If the biometric information on the card and that of the possessor of the card do match, authorization data is recorded on the card as shown by arrow B and block 120. In other words, a favorable comparison of biometric data occurs before authorization data is recorded. Authorization data is, for example, any data which specifies the type of access which may be granted to the card possessor. It may limit the possessor's access to one or more specific locations, a specified amount of access time or otherwise.

Verification terminals can be connected to the library directly or through the local database for comparison of the library information with both the acquired and read information. In the event that there is such a connection then additional steps may be taken as follows. If the information of the card and the possessor of the card match, that information is then sent by telecommunications to the library, directly or through the local database and compared as shown in block 95 with the library information. If the information matches biometric information at the library corresponding to a different name or other common identification, as indicated by arrow G, authorization is denied and apprehension may be initiated 73. Similarly, if the information matches that at the library but the library indicates that a replacement card has been issued and the information on the card lacks the additional information indicating that it is a replacement card, authorization is denied and apprehension may be initiated 73. If, on the other hand, the information sent to the library matches that at the library under the same name and other common identification, as shown by arrow C, a signal is sent to the verification terminal authorizing access benefits, which are recorded 120 on the card on the temporary storage medium. Access benefits are for example, limited. Authorization data can be stored in a local database and linked to the corresponding biometric information as illustrated in block 123.

With reference to FIG. 3B, at a local checkpoint terminal, biometric information is acquired from the possessor of the card, as shown in block 122. The checkpoint terminal communicates with the local database to determine which biometric information to acquire. The acquired biometric information is of the same type as the biometric information acquired at the verification terminal that was desirably, randomly selected. Biometric information is also read from the card, according to block 124. The order of performance of steps 122 and 124 is immaterial. The biometric information of the card and of the possessor of the card is then compared 126. If the biometric information on the card and that of the possessor of the card do not match, steps 122, 124, and 126 are repeated to confirm a mismatch. If a mismatch is confirmed, as shown by arrow a, authorization is denied, as shown by block 130, and apprehension measures may be initiated. If there is a favorable comparison, for instance, the biometric information is a match, then additional authorization steps occur. The authorization data specifying authorized card use and any specified limits, as seen by arrow H and step 150, is read. Authorization data can be read 150 simultaneously with biometric data or alternatively, it can be read before or after the indelible data is read. Additional authorization steps include determining whether pre-determined criteria are met, as shown in block 151. If pre-determined criteria are met, as shown in block 151 and by arrow D, access to a designated area according to authorization data is granted as illustrated by block 153. For instance, the pre-determined criteria can include a cardholder being at the correct location. Thus, if the cardholder is at the checkpoint terminal that corresponds with the location specified by the authorization data, access limited by the terms of the authorization data is granted. In another example, if the authorization data of the card corresponds to, or is the same as, the authorization data stored in the database, and the card possessor is attempting to gain access to the area in accordance with the authorization data, access is granted. The database links the authorization data with the cardholder's selected biometric information. Though the cardholder's biometric information may match with the biometric information on the card, if the authorization data does not grant access beyond the checkpoint in question or if other pre-determined criteria are not met, authorization is denied as shown by block 130. In one example, if a non-favorable comparison occurs, for instance, if the authorization data linked to the biometric data in the database is not the same as the authorization data on the card, authorization will be denied as shown by arrow A. This prevents a cardholder from tampering with the temporary stored authorization data and prevents him from altering the temporary storage area to grant access to areas to which he was not intended to have access. If the criteria is met, for instance if the authorization data is the same as the authorization data linked to the biometric information in the database and if the cardholder is at the correct location or checkpoint terminal, authorization is granted as shown by block 153 according to the terms of the authorization data.

Checkpoint terminals can be connected to the library directly or through the local database. In the event that there is such a connection, then additional steps may be taken as follows. If the information of the card and the possessor of the card match, that information is then sent by, for example, telecommunications to the library, directly or through local database after uploading the data, as shown by step 139, where it is compared, as shown by block 128, with the library information. If the information matches biometric information at the library corresponding to a different name or other common identification, as indicated by arrow S, authorization is denied and apprehension may be initiated 130. Similarly, if the information matches that at the library but the library indicates that a replacement card has been issued and the information on the card lacks the additional information indicating that it is a replacement card, authorization is denied and apprehension may be initiated 130. If, on the other hand, the information sent to the library matches that at the library under the same name and other common identification, a determination is made as to whether limited card use is authorized as shown by arrow L and steps 150 and 151. Thus, the checkpoint terminal thereupon indicates that access to the designated location is granted according to that access allowed by the data on the temporary storage medium as seen in step 153.

Once those access benefits have been exhausted, a possessor of the card must revisit the verification terminal in order to obtain further access benefits. In this manner, the security of the card and the access to a designated location are enhanced.

What is claimed is:

1. A system for controlling access to a designated area comprising:
a card having a permanent storage medium disposed adjacent a temporary storage medium;
a first writing device having means for acquiring random biometric information of an individual and for indelibly writing a template of said random biometric information on said permanent storage medium;
a verification terminal having means for reading a template written on said card, for acquiring random biometric information of an individual possessing said card, for comparing said template with said random biometric information of said individual possessing said card and for writing authorization data on said temporary storage medium specifying limited access authorized in response to a favorable comparison;
a database having means for storing said random biometric identification information; and
a plurality of local checkpoint terminals in communication with said database and having means for reading said authorization data, for reading said template of said permanent medium and for comparing said template of said permanent medium with that of a card possessor and in response to a favorable comparison, authorizing access in accordance with said authorization data.

2. The system of claim 1 wherein said first writing device has means for acquiring common identification information from an individual and for indelibly writing a template of said common identification information on said permanent storage medium.

3. The system of claim 2 wherein said database has means for storing said common identification information.

4. The system of claim 3 further comprising an identification library having means for communicating with said database, means for storing said biometric identification and associated common identification information of said individual, and means for comparing said information with previously stored card information such that a duplication alert is sent to said verification terminal if said biometric identification information matches biometric identification information previously stored and said associated common identification differs from an associated common identification previously stored.

5. The system of claim 1 wherein said database has means for storing said common identification information.

6. The system of claim 1 wherein said biometric identification information and authorization data are linked in said database.

7. The system of claim 1 wherein said verification terminal is disposed at a location having a geographical location different from a geographic location at least one of said plurality of checkpoint terminals.

8. The system of claim 1 wherein said permanent medium includes an optical stripe.

9. The system of claim 1 wherein said permanent medium includes a semiconductor memory chip.

10. The system of claim 1 wherein said temporary medium includes a semiconductor memory chip.

11. The system of claim 1 wherein said temporary medium includes a magnetic recording stripe.

12. A system for authorizing access comprising:
a personal identification card having a first and a second data storage medium, said first medium capable of being written with data indelibly written, said second medium capable of being written repeatedly;
a verification terminal having means for acquiring random biometric information from a person, for indelibly writing said first medium with said random biometric identification information, for subsequently reading said random biometric information of said first medium, for comparing said random biometric identification information read from said first medium with that of a possessor of said card, and for writing authorization data on said second data storage medium specifying limited access authorized in response to a favorable comparison;
a database having means for storing said random biometric identification information; and
a plurality of local checkpoint terminals in communication with said database and having means for reading said authorization data and for reading said random biometric information of said first medium and for comparing said random biometric information read from said first medium with that of a possessor of said card and that of a possessor of said card and in response to a favorable comparison, authorizing access in accordance with said authorization data.

13. The system of claim 12 wherein said authorization data is stored in said database and linked to said biometric information in said database.

14. The system of claim 13 further comprising a means for comparing said authorization data stored in said database with said authorization data of said second storage medium and upon a favorable comparison, authorizing access.

15. The system of claim 12 wherein said indelible information further includes associated common identification, the system further comprising an identification library having a means for communicating with said database, a means for storing said biometric identification and associated common identification information of a person, and a means for comparing said information with previously stored card information such that a duplication alert is sent to said verification terminal if said biometric identification matches a biometric identification previously stored and said associated common identification differs from an associated common identification previously stored.

16. The system of claim 12 wherein said verification terminal further includes a means for writing said indelible information on said first data storage medium.

17. A method for controlling access to a designated location comprising:
acquiring random biometric information from an individual and recording said random biometric information indelibly on a card;
comparing said random biometric information recorded on said card with subsequently acquired random biometric information of an individual possessing said card at a verification terminal;
writing authorization data on said card if said comparison is favorable at said verification terminal; and
comparing random biometric identification information retrieved from an individual with said indelibly recorded information and authorizing individual access in accordance with said authorization data upon a favorable comparison at a checkpoint terminal.

18. The method according to claim 17 further comprising indelibly recording common identification information on said card.

19. The method of claim 17 further comprising preventing access upon a non-favorable comparison at said checkpoint terminal.

20. The method of claim 17 further comprising storing said authorization data in a database.

21. The method of claim 17 further comprising comparing said authorization data stored in said database with authorization data stored on said card at said checkpoint terminal wherein a favorable comparison authorizes access of said individual in accordance with said authorization data.

22. The method of claim 17 wherein said authorization data specifies terms limiting access to a designated location.

23. The method of claim 22 further comprising before comparing random biometric information retrieved from an individual with said indelibly recorded information, storing said acquired random biometric information in a database and determining which type of random biometric information to request from an individual by communicating with said database at said checkpoint terminal.
